(19) United States
(12) Patent Application Publication
(10) Pub. No.: US 2008/0086444 A1
(43) Pub. Date: Apr. 10, 2008

(54) SYSTEM AND METHOD FOR IMPROVING CARDINALITY ESTIMATION IN A RELATIONAL DATABASE MANAGEMENT SYSTEM

(75) Inventors: Xiaohui Yu, Maple (CA); Calisto P. Zuzarte, Pickering (CA)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/539,721

(22) Filed: Oct. 9, 2006

(51) Int. Cl. G06F 17/30

(52) U.S. Cl. 707/2

(57) ABSTRACT

A system and method for improving cardinality estimation in a relational database management system is provided. The method is suitable for use with a query optimizer for improved estimation of various predicates in the query optimizer's cost estimation plan by combining pre-computed statistics and information from sampled data. The system and method include sampling a relational database for generating a sample data set and estimating cardinalities of the sample data set. The estimated cardinalities sample data sets are reduced in accordance with the present invention by determining a first and second weight set, and minimizing a distance between the first and second weight set.

### TRADEMARKS

IBM® is a registered trademark of International Business Machines Corporation, Armonk, New York, U.S.A. Other names used herein may be registered trademarks, trademarks or product names of International Business Machines Corporation or other companies.

### BACKGROUND OF THE INVENTION

1. Field of the Invention

This invention relates to database management systems and more particularly to a method and system for improved cardinality estimation after applying various predicates in a query optimizer's plan by combining pre-computed statistics and information from sampled data.

2. Description of the Related Art

A database management system (DBMS) comprises the combination of an appropriate computer, direct access storage devices (DASD) or disk drives, and database management software. A relational database management system is a DBMS which uses relational techniques for storing and retrieving information. The relational database management system or RDBMS comprises computerized information storage and retrieval systems in which data is stored on disk drives or DASD for semi-permanent storage. The data is stored in the form of tables which comprise rows and columns. Each row or table has one or more columns.

The RDBMS is designed to accept commands to store, retrieve, and delete data. One widely used and well known set of commands is based on the Structured Query Language or SQL. The term “query” refers to a set of commands in SQL for retrieving data from the RDBMS. The definitions of SQL provide that a RDBMS should respond to a particular query with a particular set of data given specified database content. SQL however does not specify the actual method to find the requested information in the tables on the disk drives. There are many ways in which a query can be processed and each consumes a different amount of processor and input/output access time. The method in which the query is processed (i.e., a query plan) affects the overall time for retrieving the data. The time taken to retrieve data can be critical to the operation of the database. It is therefore important to select a method for finding the data requested in a query which minimizes the computer and disk access time, and therefore, optimizing the cost of doing the query.

A database system user retrieves data from the database by entering requests or queries into the database. The RDBMS interprets the user's query and then determines how best to go about retrieving the requested data. In order to achieve this, the RDBMS has a component called the query optimizer. The RDBMS uses the query optimizer to analyze how to best conduct the user's query of the database with optimum speed in accessing the database being the primary factor. The query optimizer takes the query and generates a query execution plan. The query plan comprises a translation of the user's SQL commands in terms of the RDBMS operators. There may be several alternative query plans generated by the query optimizer, each specifying a set of operations to be executed by the RDBMS.

The many query plans generated for a single query ultimately differ in their total cost of obtaining the desired data. The query optimizer then evaluates these cost estimates for each query plan in order to determine which plan has the lowest execution cost. In order to determine a query plan with the lowest execution cost, the query optimizer uses specific combinations of operations to collect and retrieve the desired data. When a query execution plan is finally selected and executed, the data requested by the user is retrieved according to that specific query plan however manipulated or rearranged.

Query optimizers in most relational database systems rely on cost estimation of various candidate query execution plans to select a cost effective plan. Accurate plan costing can help avoid intolerably slow plans. A key ingredient in cost estimation is to estimate the selectivity of various predicates in order to obtain the cardinality estimates which are the sizes of the intermediate results. Better cardinality estimation allows the query optimizer to get better query execution plans.

Before our invention methods for selectivity estimation fall into two broad categories, synopsis-based and sampling-based. Synopsis-based methods, such as histograms, incur minimal overhead at query optimization time and thus are widely used in commercial database systems. Sampling-based methods are more suited for ad-hoc queries, but often involve high I/O cost because of random access to the underlying data. Though both methods serve the same purpose of selectivity estimation, their interaction in the case of selectivity estimation for conjuncts of predicates on multiple attributes is largely unexplored.

In terms of methodology, existing work on selectivity estimation takes two fundamentally different approaches: one is based on synopsis data structures and the other is based on sampling.

Synopsis-based approaches seek to pre-compute summary data structures which capture statistics on the data (attribute value distributions). Such synopses are stored in the database catalogs, and subsequently used for estimation when required. A prominent example in this class of approaches is histograms, which have been proposed in recent years, aiming to improve the accuracy of histogram-based selectivity estimation. Almost all major commercial database management systems (e.g., IBM® DB2® Universal Database™ product (DB2 UDB), Oracle, SQL Server) keep some form of histograms in their catalogs and use them for selectivity estimation.

Sampling-based approaches are more query-driven in nature, in the sense that data is not accessed until optimization time. Given a query, a sample is derived from the database, and selectivities are estimated based on this sample. There exists an extensive literature on sampling-based methods for selectivity estimation. In recent years, all of the major commercial database system vendors have incorporated sampling capabilities into their engines.

Both prior art approaches have their advantages and disadvantages. Synopsis structures, such as histograms, only need to be computed once and can be used many times while incurring minimal overhead at selectivity estimation time. However, it is difficult to capture all useful information in the limited space. For example, the one-dimensional histograms commonly used in the commercial DBMS's do not provide correlation information between attributes. Although it is possible to compute multi-dimensional histograms for some attribute combinations, it is generally not feasible to compute and store the multi-dimensional histograms for all attribute combinations, because the number of combinations is exponential in the number of attributes [5]. Without knowing of the query workload, deciding which combinations of attributes to choose in order to construct multi-dimensional histograms can be very difficult.

Sampling approaches, on the other hand, are able to provide such crucial information through a representative sample of the data. The downside, however, is that sampling at selectivity estimation time incurs non-trivial cost, because in order to obtain a fairly accurate estimate, sometimes a significant portion of the data might have to be accessed. Since sampling requires random access, which is much slower than sequential access, it is possible that the cost of sampling exceeds that of a sequential scan of the data when the sample size is relatively large.

By way of example, if we are interested in predicates taking the form of Q=P₁̂P₂̂ . . . ̂Pₘ, where each Pᵢ(1≦i≦m) is a simple predicate of the form (attribute op constant) with op being one of the comparison operators <,≦,=,≠,≧, or >. The selectivity sᵢ(∈[0,1]) is defined as the fraction of tuples on which predicate Pᵢ evaluates to true, i.e., sᵢ=Nᵢ/N, where N is the number of tuples in the table, and Nᵢ is the number of tuples satisfying Pᵢ. The selectivity of the conjuncts of predicates Q, denoted by s_{Q}(∈[0,1]), is the fraction of tuples satisfying all the Pᵢ's simultaneously. s_{Q} is the quantity to estimate. When there is no ambiguity, for purposes of clarity, this description use s as a shorthand for s_{Q}.

The query optimizer measures the error of an estimate ŝ by the absolute relative error, as provided in Eq. (1).

$$E ( \hat{s} ) = \frac{\vert \hat{s} - s \vert}{s} . \qquad ( 1 )$$

The following scenario is used as an example. Consider a table R with N=10,000 tuples and three attributes Aᵢ(i=1,2,3). Let P₁=(A₁=1), and P₂=(A₂=1). For example, if there is a need to estimate the selectivity of the following query: Q=P₁̂P₂. If there are 500 tuples satisfying Q, then the true selectivity of Q is s=500/10000=0.05.

Synopsis-based estimation. Assume that we have access to synopsis structures for all individual attributes involved such that selectivity estimates sᵢ(1≦i≦m) can be obtained. Without any information regarding the correlation between attributes, optimizers in current database systems estimate s_{Q} based on the assumption that the values in distinct attributes are independently distributed. In other words, knowing that a tuple satisfies a predicate on one attribute does not give any information as to whether it satisfies a predicate on another. Therefore, s is estimated by taking a product of the selectivity estimates of individual predicates,

$$i . e . , {\hat{s}}_{his} = {\prod }_{i = 1}^{m} {s}_{i} .$$

In the running example, suppose we have access to single-attribute histograms on A₁ and A₂, and therefore we can derive the selectivities of the two predicates, namely s₁ and s₂, from the histograms. Suppose s₁=0.6, and s₂=0.3. If we assume A₁ and A₂ are independent, then the selectivity of Q is estimated to be ŝₕᵢₛ=s₁·s₂=0.18, and the error is E(ŝₕᵢₛ)=|0.18−0.05|/0.05=260%.

This simple estimation scheme gives accurate estimates when the attributes are indeed independent. Real-life data sets, however, almost always demonstrate a certain degree of correlation between attributes, therefore, making the attribute-value independence assumption often leads to erroneous estimates. In the above example, treating the attributes A₁ and A₂ as independent incurs a large error (260%).

As another example, suppose we have the following query on a CAR table in a vehicle information database: Q=(MAKE=“BMW”)̂(MODEL=“M3”), and we know through one-dimensional histograms that the selectivity of the predicate (MAKE=“BMW”) is 0.1, and that the predicate (MODEL=“M3”) has a selectivity of 0.01. The optimizer then would estimate the selectivity of Q as 0.1×0.01=0.001, as per the attribute-value independence assumption.

Note, however, that there is strong correlation between the attributes MAKE and MODEL. Because M3 is exclusively made by BMW, all tuples satisfying the predicate MODEL=“M3” would also satisfy the predicate MAKE=“BMW”. Therefore, the selectivity of Q is actually 0.01, 10 times that of the estimated selectivity.

Sampling-based estimation. Now let us look at how to obtain an estimate of the selectivity based on a sample of the data. Suppose a random sample S of size n is taken from the queried table R of size N, where the inclusion probability (the probability of being selected into the sample) of the j-th tuple is πⱼ. The Horvitz-Thompson (HT) estimator [for the selectivity of the query Q, given the sample S, is

$${s}_{sp 1} = \frac{1}{N} {\sum }_{j ∈ S}^{ } \frac{{y}_{j}}{{π}_{j}} \qquad ( 2 )$$

where yⱼ is an indicator variable such that yⱼ=1 if tuple j satisfies Q, and yⱼ=0 otherwise. In the case of simple random sampling (SRS), where the inclusion probabilities are all equal to n/N, Eq. (2) simplifies to

$${\hat{s}}_{sp 1} = \frac{1}{N} {\sum }_{j ∈ S}^{ } {y}_{j} .$$

In the running example, suppose we tale an SRS S of size n=100 from table R. Clearly, the inclusion probabilities for tuples in R are all equal to 100/10000=0.01. If 9 tuples in the sample satisfy Q, then the HT estimator is ŝₛₚₗ=9/100=0.09, and the error is E(ŝₛₚₗ)=80%.

A major problem with the use of sampling is the I/O overhead incurred. Since sampling requires random access to data, it is often the case that even if a very small sample is taken, the associated I/O cost is comparable to that of a full sequential scan of the data. For example, if each page contains 50 tuples, and the sample rate is higher than 2%, essentially all pages have to be accessed because 50×2%=1.

The prior art shows that the expected fraction f of pages to be accessed for a sample rate of q is given by f=1−(1−q)^{c}, where c is the number of tuples on each page. It is evident that f decreases very fast as the sample rate drops, which means that achieving the same level of accuracy with a lower sample rate, will result in significant I/O savings.

There is no known previous work exploring the interaction of sampling based and synopsis based approaches in order to make consistent use of both sources of information to get reasonably accurate cardinality estimates and at the same time not rely on a very large sample to do that. Therefore, there exists a need for a hybrid system and method that combines both sampling based and synopsis based query estimations.

### SUMMARY OF THE INVENTION

The shortcomings of the prior art are overcome and additional advantages are provided through the provision of a hybrid sampling and synopsis selectivity estimation method and system. Sampling-based methods usually associate with each sampled tuple a sampling weight reflecting its inclusion probability (i.e., the probability of being selected to the sample), which is used to produce a selectivity estimate. Given selectivities of individual predicates Pᵢ (which can be obtained from attribute synopses), in addition to the sample, better estimates may be obtained by adjusting sampling weights, in a way that is consistent with the information on individual selectivities obtained from the synopses.

In particular, the weights of the tuples in the sample are adjusted, while maintaining the new weights as close as possible to the original weights. New weights that can then be used to obtain improved selectivity estimates are derived via an optimization problem solution.

In accordance with one embodiment of the present invention a general numerical solution to this optimization problem, as well as an iterative solution based on the intrinsic structure of the problem is provided. Also provided are two different measures of “closeness” between the new weights and the original weights, namely the linear distance function and the multiplicative distance function, and are compared in terms of computational efficiency and interpretability. Also provided are asymptotic bounds on the estimation errors.

In accordance with another embodiment of the present invention a method for selectivity estimation for conjunctive predicates for use in a query optimizer for a relational database management system is provided. The method includes sampling a relational database for generating a sample data set and estimating cardinalities of the sampled data set. The method also includes iteratively adjusting the estimated cardinalities of the sample data set by determining a first and second weight set and minimizing the distance between the first weight set and the second weight set.

The invention is also directed towards a relational database management system for improving cardinality estimation for use with a computer system wherein queries are entered for retrieving data. The system includes means for sampling a relational database for generating a sample data set and means for estimating cardinalities of the sampled data set. The system also includes means for reducing the estimated cardinalities of the sample data set via means for determining a first and second weight set and minimizing the distance between the first weight set and the second weight set.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution by which a program storage device readable by a machine, tangibly embodying a program of instructions executable by the machine performs a method for improving cardinality estimation in a relational database management system. The method includes sampling a relational database for generating a sample data set and determining individual and combined predicates. The method also includes estimating cardinalities of the sampled data set with respect to the individual and combined predicates and reducing the estimated cardinalities of the sampled data set. The program of instructions reduces the cardinalities of the sample data set by first determining a plurality of tuples in the sampled data set and weighting each of the plurality of tuples in the sample data set according to predetermined statistics. The method then determines a second weight set using a distance function to derive the second weight set. The distance function is selected from the group consisting of a linear distance function and a multiplicative distance function and is used to minimize the distance between the first weight set and the second weight set.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram showing software components of a relational database management system suitable for a method for estimating cardinalities according to the present invention;

FIG. 2 is a block diagram showing a data processing system employing the present invention;

FIG. 3 illustrates one example of a method for computing the calibration estimator in accordance with an embodiment of the present invention;

FIG. 4 illustrates one example of an alternate method for determining the calibration estimator in accordance with an embodiment of the present invention;

FIG. 5A is a graph comparing embodiments of the present invention with prior art methods in terms of accuracy vs. correlation;

FIG. 5B is a graph comparing embodiments of the present invention with prior art methods in terms of accuracy vs. data skew;

FIG. 6A is a graph comparing embodiments of the present invention with prior art methods in terms of accuracy vs. sample rate;

FIG. 6B is a graph comparing embodiments of the present invention with prior art methods in terms of accuracy vs. number of attributes; and

FIG. 7 is a graph comparing an embodiment of the present invention with prior art methods in terms of accuracy vs. sample rate on Census Income data.

The detailed description explains the preferred embodiments of the invention, together with advantages and features, by way of example with reference to the drawings.

### DETAILED DESCRIPTION OF THE INVENTION

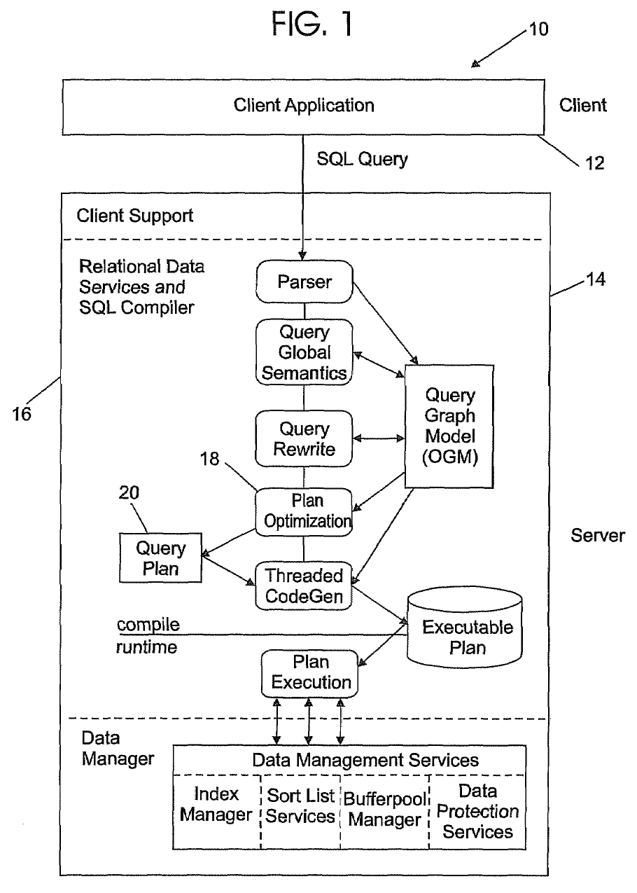

Reference is made to FIG. 1 which shows in block diagram form a Relational Database Management System or RDBMS system 10 suitable for use with a method according to the present invention. One skilled in the art will be familiar with how a RDBMS is implemented. Such techniques are straightforward and well known in the art. Briefly, the RDBMS 10 comprises a client application module 12 and a server module 14 as shown in FIG. 1. One of the functions of the server 14 is to process the SQL query entered by the database user. The server 14 comprises a relational data services and SQL compiler 16. The SQL compiler 16 includes a plan optimization module 18 or query optimizer. The primary function of the query optimizer 18 is to find an access strategy or query plan that would incur or result in minimum processing time and input/output time for retrieving the information requested by the user. In FIG. 1, the query plan is represented by block 20.

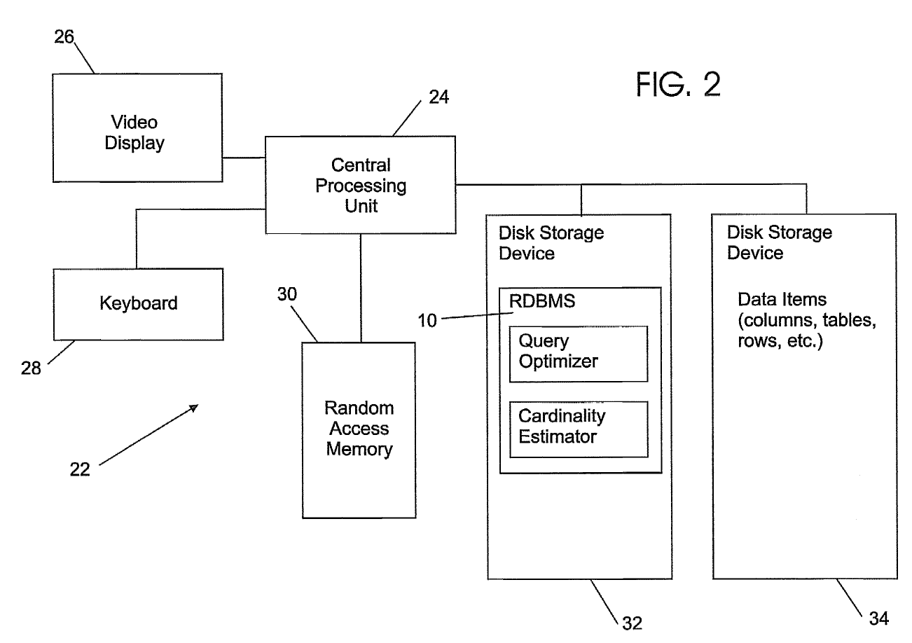

Reference is next made to FIG. 2 which shows a data processing system 22 incorporating the present invention. The data processing system 22 comprises a central processing unit 24, a video display 26, a keyboard 28, random access memory 30 and one or more disk storage devices 32. One skilled in the art will recognize the data processing system 22 a conventional general purpose digital computer. In FIG. 2, the relational database management system 10 incorporating the present invention includes a software module which includes a query optimizer, and which is stored or loaded on the disk storage device 32. Data items, e.g. cards, tables, rows, etc. which are associated with the relational database management system 10 can be stored on the same disk 32 or on another disk 34.

The method, a hybrid approach to selectivity estimation for conjunctive predicates (HASE), according to the invention makes consistent use of synopses and sample information when both present. To achieve this goal, the method uses a novel estimation scheme utilizing a powerful mechanism called generalized raking. The method formalizes selectivity estimation in the presence of single attribute synopses and sample information as a constrained optimization problem. By solving this problem, the method obtains a new set of weights associated with the sampled tuples, which has the advantageous property of reproducing the known selectivities when applied to individual predicates.

It will be understood that the description presented herein will be mainly concerned with selectivity estimation for conjunctive predicates of the form Q=P₁̂P₂ . . . Pₘ where each component Pᵢ is a simple predicate on a single attribute, taking the form of (attribute op constant) with op being one of the comparison operators <,≦,=,≠,≧, or >(e.g., R.a=100 or R.a≦200).

### Calibration

For example, for a sample of data with known selectivities of individual predicates Pᵢ. The method begins with an estimator constructed based on the sample only, without reference to any additional information, such as the HT estimator (Eq. (2)). For each tuple j in table R, in addition to the variable of interest yⱼ, the method in accordance with the invention also associates with it an auxiliary vector xⱼ to reflect the results of evaluating Pᵢ on j. For purposes of this example, each predicate Pᵢ divides tuples in R into two disjoint subsets, Dᵢ and D̅ᵢ, according to whether they satisfy the predicate or not. Also for purposes of this example, further define Dₘ₊₁=R i.e., j ∈ Dₘ₊₁ for all j. Let xⱼ be a column vector of length m+1: xⱼ^{T}=(xⱼ₁, . . . ,xⱼₘ,x_{j,m+1}), with the i-th (1≦i≦m+1) element being 1 if j ∈ Dᵢ, and 0 otherwise. For instance, in the running example described above, xⱼ^{T}=(1,0,1) indicates that tuple j satisfies P₁, but not P₂.

Let tₓ^{T}=(tₓ₁, . . . ,tₓₘ,t_{x,m+1})=1/N Σ_{j∈R} xⱼ. Clearly, tₓᵢ=1/N Σ_{j∈S} xⱼᵢ=sᵢ (1≦i≦m), the selectivity of predicate Pᵢ, and t_{x,m+1}=1. Therefore,

tₓ^{T}=(s₁,s₂, . . . ,sₘ,1) (3)

Also, for purposes of this example sᵢ can be obtained based on synopsis structures, and xⱼ are observed for each tuple j ∈ S. This allows construction of a new estimator (the calibration estimator)

$${\hat{s}}_{cal} = \frac{1}{N} {\sum }_{j ∈ S}^{ } {w}_{j} {y}_{j} , \qquad ( 4 )$$

where the weights wⱼ are as close to the weights dⱼ=1/πⱼ as possible according to some distance metric (recall that πⱼ is the inclusion probability of j), and where

$$\frac{1}{N} {\sum }_{j ∈ S}^{ } {w}_{j} {y}_{j} = {t}_{x} , \qquad ( 5 )$$

meaning that the weighted average of the observed xⱼ has to reproduce the known selectivities sᵢ.

In light of the definition of xⱼ and Eq. (3), Eq. (5) can be rewritten as

$$\frac{1}{N} {\sum }_{j ∈ S ⋂ {D}_{i}}^{ } {w}_{j} = {s}_{i} , \\ i = 1 , 2 , … , m + 1. \qquad ( 6 )$$

where sₘ₊₁=s. Now wⱼ has a natural representation interpretation: it is the number of tuples “represented” by the sampled tuple j.

In the running example, Eq. (6) becomes

$$\frac{1}{10000} {\sum }_{j ∈ S ⋂ {D}_{1}}^{ } {w}_{j} = 0.6 , \frac{1}{10000} {\sum }_{j ∈ S ⋂ {D}_{2}}^{ } {w}_{j} = 0.3 , and \frac{1}{10000} {\sum }_{j ∈ S}^{ } {w}_{j} = 1 \qquad ( 7 )$$

Although in general, there can be many possible choices for the sets of weights {wⱼ} satisfying the constraints in Eq. (6), the goal of the method is to select a set of new weights that are as close as possible to the original weights dᵢ=1/πᵢ, which enjoy the desirable property of producing unbiased estimates. By keeping the distance between the new weights and the original weights as small as possible, in accordance with one method of the invention, the new weights remain nearly unbiased. Thus, the method advantageously provides a constrained optimization solution as described herein.

The constrained optimization solution. Let D(x) be a distance function (with x=wⱼ/dⱼ) that measures the distance between the new weights wⱼ and the original weights dⱼ. The query optimizer assures that D(x) satisfies the following requirements (for reasons that will become clear later): (i) D is positive and strictly convex, (ii) D(1)=D′(1)=0, and (iii) D″(1)=1. The optimization for the method to determine is:

### Minimize

$${\sum }_{j ∈ S}^{ } {d}_{j} D ( {w}_{j} / {d}_{j} ) \qquad ( 8 )$$

subject to

$$\frac{1}{N} {\sum }_{j ∈ S}^{ } {w}_{j} {x}_{j} = {t}_{x} . \qquad ( 9 )$$

Here, both xⱼ and tₓ are defined earlier. Since D(wⱼ/dⱼ) can have a large response to even a slight change in wⱼ when dⱼ is small, the query optimizer minimizes Σ_{j∈S} dⱼD(wⱼ/dⱼ) instead of Σ_{j∈S} D(wⱼ/dⱼ) in order to dampen this effect. Also note that different distance functions can be used to measure the distance between {wⱼ} and {dⱼ}, as long as the distance function complies with conditions (i) to (iii).

Alternative methods of the invention can choose different distance functions. For example, the following two distance functions may be chosen for computational efficiency and interpretability. Both of these distance functions exhibit properties (i) to (iii):

The linear distance function

$${D}_{lin ( {w}_{j} / {d}_{j} )} = \frac{1}{2} {( \frac{{w}_{j}}{{d}_{j}} - 1 )}^{2} ,$$

and

The multiplicative distance function:

$${D}_{mul ( {w}_{j} / {d}_{j} )} = \frac{{w}_{j}}{{d}_{j}} log \frac{{w}_{j}}{{d}_{j}} - \frac{{w}_{j}}{{d}_{j}} + 1$$

### It will be appreciated that any suitable distance function may be chosen.

In accordance with features of the present invention the following methods may be used to solve the constrained optimization problem. One method for solving constrained optimization problems is the method of Lagrange multipliers. Note that the optimization problem can states as follows:

### Minimize

$${\sum }_{j ∈ S}^{ } {d}_{j} D ( {w}_{j} / {d}_{j} ) - {λ}^{T} ( {\sum }_{j ∈ S}^{ } {w}_{j} {x}_{j} - {Nt}_{x} ) \qquad ( 10 )$$

with respect to wⱼ(j ∈ S),
where λ=(λ₁, . . . ,λₘ,λₘ₊₁) is a Lagrange multiplier. Differentiating Eq. (10) with respect to wⱼ, to obtain:

D′(wⱼ/dⱼ)−xⱼ^{T}λ=0 (11)

Then solve the system formed by Eq. (11) and (9) for wⱼ. To do this, obtain from (11) that

wⱼ=dⱼF(xⱼ^{T}λ), (12)

where F(x) is the inverse function of D′(x). Conditions (i)-(iii) dictate that the inverse function always exists, and F(0)=F′(0)=1. Substituting (12) into Eq. (9), results in the calibration equations

$${\sum }_{j ∈ S}^{ } {d}_{j} F ( {x}_{j}^{T} λ ) {x}_{j} = {Nt}_{x} , \qquad ( 13 )$$

which can be solved numerically using Newton's method.

$$Let φ ( λ ) = {\sum }_{j ∈ S}^{ } {d}_{j} F ( {x}_{j}^{T} λ ) {x}_{j} - {Nt}_{x} . \\ Then {φ}^{′} ( λ ) = \partial φ ( λ ) / \partial λ = {\sum }_{j ∈ S}^{ } {d}_{j} {F}^{′} ( {x}_{j}^{T} λ ) {x}_{j} {x}_{j}^{T} .$$

Then obtain successive estimates of λ, denoted by λₖ (k=0,1, . . . ), through the following iteration:

λₖ₊₁=λₖ+[φ′(λₖ)]⁻¹φ(λₖ) (14)

take λ₀=0. Since one has

$$φ ( 0 ) = {\sum }_{j ∈ S}^{ } {d}_{j} F ( 0 ) {x}_{j} - {Nt}_{x} = {\sum }_{j ∈ S}^{ } {d}_{j} {x}_{j} - {Nt}_{x} , \\ and$$

$${φ}^{′} ( 0 ) = {\sum }_{j ∈ S}^{ } {d}_{j} {F}^{′} ( 0 ) {x}_{j} {x}_{j}^{T} = {\sum }_{j ∈ S}^{ } {d}_{j} {x}_{j} {x}_{j}^{T} ,$$

the first iteration yields λ₁=(Σ_{j∈S} dⱼxⱼxⱼ^{T})⁻¹(Σ_{j∈S} dⱼxⱼ−Ntₓ). The subsequent values of λₖ can be obtained following Eq. (14) until convergence.

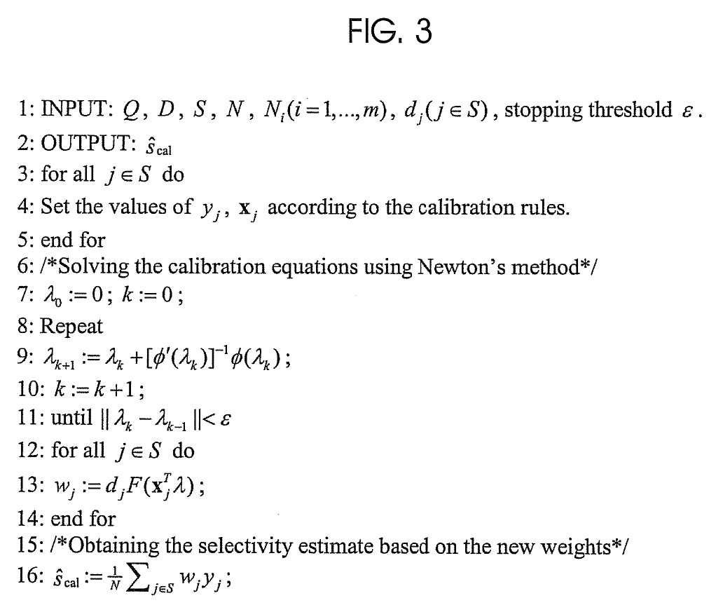

In summary, the method to estimate the selectivity of Q is presented in FIG. 3. Continuing the running example, the true frequencies obtained by evaluating the query Q on table R, and the observed frequency information based on a simple random sample S are given in Tables 1(a) and 1(b) showing true frequencies and observed frequencies from the sample, respectively (both tables are normalized so that all frequencies sum up to 1). The last row and column in each table correspond to the marginal frequencies.

From Table 1(a) and Table 1(b), it is seen that the true selectivity of Q is 0.05 (the cell corresponding to P₁=truêP₂=true in FIG. 1(a)), and the sampling-based selectivity estimate is 0.09 (the cell corresponding to P₁=trueΛP₂=true in Table 1(b)).

TABLE 1(a)
True frequencies

| | P₂ = true | P₂ = false | — |
|---|---|---|---|
| P₁ = true | 0.05 | 0.55 | .60 |
| P₁ = false | 0.25 | 0.15 | .40 |
| — | .30 | .70 | |

TABLE 2(b)
Observed frequencies

| | P₂ = true | P₂ = false | — |
|---|---|---|---|
| P₁ = true | 0.09 | 0.56 | .65 |
| P₁ = false | 0.24 | 0.11 | .35 |
| — | .33 | .67 | |

Clearly, the marginal frequencies obtained from the sample do not agree with the true marginal frequencies; therefore, calibration is needed. Applying the method shown in FIG. 3 to solve the calibration equations as shown in Eq. (7), obtains the following calibrated weights (using the multiplicative distance function):

wⱼ≈60 for j ∈ S∩D₁∩D₂,wⱼ≈102 for j ∈ S∩D₁∩ D̅₂

wⱼ≈97 for j ∈ S∩ D̅₁∩D₂,wⱼ≈140 for j ∈ S∩ D̅₁∩ D̅₂.

The selectivity estimate can then be determined:

$${\hat{s}}_{cal} = \frac{1}{N} {\sum }_{j ∈ S}^{ } {w}_{j} {y}_{j} = \frac{1}{N} {\sum }_{j ∈ S ⋂ {D}_{1} ⋂ {D}_{2}}^{ } {w}_{j} = 60 \times 9 / 10000 = 0.054 .$$

The estimation error is E(ŝ_{cal})=|0.054−0.05|/0.05=8%. Compared with the error of the prior art synopsis-based estimate E(ŝₕᵢₛ)=260% and the error of the prior art sampling-based estimate E(ŝₛₚₗ)=80%, this method represents a significant improvement in the estimation accuracy.

An alternative implementation. Now is presented an alternative method for solving the calibration equations, which takes advantage of the intrinsic structure of the equations in (6) and does not require matrix inversion.

Since wⱼ=dⱼF(xⱼ^{T}λ), Eq. (6) becomes

$$\frac{1}{N} {\sum }_{j ∈ S ⋂ {D}_{1}}^{ } {d}_{j} F ( {x}_{j}^{T} λ ) = {s}_{i} , \\ i = 1 , … , m + 1. \qquad ( 15 )$$

Observe that the i-th Eq. (2≦i≦m) can be solved for λᵢ, assuming all other λₗ(l≠i) are known, and the first and last equations can be solved for λ₁ and λₘ₊₁ assuming all other λₗ(l≠1,l≠m+1) are known.

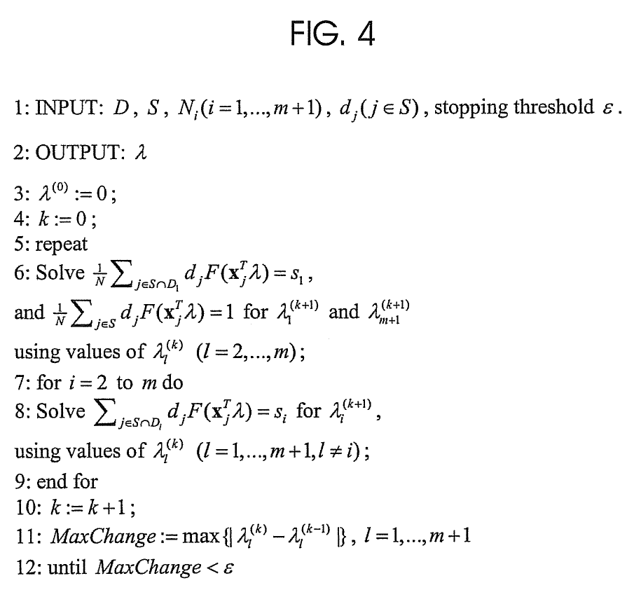

This method is shown in FIG. 4. It will be appreciated that such an iterative procedure converges to a proper solution, and in the case of multiplicative distance functions, this method yields a variant of the classical iterative proportional fitting algorithm. Replacing lines 6 to 11 in FIG. 3 with the method shown in FIG. 4 results in an alternative estimation method.

Distance measures. We now present the implications of the choice of distance functions D described earlier. In general, different distance functions result in different calibration estimators. However, it will be understood that regardless of the distance functions used (as long as the functions comply with conditions (i)-(iii)), the estimates obtained using the outcome of the specific optimization problem will converge asymptotically.

Therefore, for medium to large sized samples (empirically, with sample size greater than 30), the choice of distance function does not have a heavy impact on the properties of the estimator; in general only slight differences in the estimates produced by using different functions will arise.

The main difference between the distance functions is thus their computational efficiency as well as interpretability.

For the linear function, Dₗᵢₙ, D′(x)=x−1; therefore, the inverse function is F(z)=z+1. In FIG. 2, it is can be verified that λ converges at

λ₁=(Σ_{j∈S} dⱼxⱼxⱼ^{T})⁻¹(Σ_{j∈S} dⱼxⱼ−tₓ).

Therefore, when the linear function is used, only one iteration is required, which makes the linear method the faster of the two distance functions considered here. A major drawback of this function is that the weights can be negative. This can lead to negative selectivity estimates. For instance, in the running example, taking a sample of size 10 from R, and the observed frequencies are the following: P₁=true∩P₂=true: 2; P₁=true,P₂=false: 5; P₁=false∩P₂=true: 3; P₁=false∩P₂=false: 0. Solving the calibration equation, results in wⱼ=−500 for j ∈ S∩D₁∩D₂. Therefore, the selectivity estimate ŝ_{cal}=2×(−500)/10000=−0.1. Negative weights and selectivity estimates do not have a natural interpretation and thus are undesirable. Note that, however, this usually only occurs for small-sized samples. When the sample size gets large, all estimators with distance functions satisfying conditions (i)-(iii) are asymptotically equivalent and give positive weights and selectivity estimates.

For the multiplicative function, Dₘᵤₗ, D′(x)=log x; the inverse function is therefore F(z)=e^{z}. When the multiplicative function is used, it may require more than one iteration, but it often converges after only a few iterations (typically two in our experiments). An advantage of using this function is that it always leads to positive weights because wⱼ=dⱼF(xⱼ^{T}λ)=dⱼ exp {xⱼ^{T}λ}>0.

Probabilistic bounds on the estimation error. Let πⱼₗ be the probability that both j and l are included in the sample, and πⱼⱼ=πⱼ. Assuming that the sampling scheme is such that the πⱼₗ's are strictly positive. Let β be a vector satisfying the equation

$${\sum }_{j ∈ R}^{ } {d}_{j} {x}_{j} ( {y}_{j} - {x}_{j}^{T} β ) = 0$$

and let Δⱼₗ=πⱼₗ−πⱼπₗ, εⱼ=yⱼ−xⱼ^{T}β. Which gives the following result on the error bounds of the estimation error. When the sample size is sufficiently large, for a given constant α ∈ (0,1), the selectivity s_{Q} is bounded by (ŝ_{cal}−z_{α/2}\sqrt{V(ŝ_{cal})},ŝ_{cal}+z_{α/2}\sqrt{V(ŝ_{cal})} with probability 1−α, where z_{α/2} is the upper alp ha/2 point of the standard normal distribution, and V(ŝ_{cal})=Σ_{j∈R} Σ_{j∈R} (Δⱼₗ/πⱼₗ)(wⱼεⱼ)(wₗεᵢ).

Proof Sketch: When the linear distance function is used, wⱼ=dⱼ(1+xⱼ^{T}λ). We know from Section 3.5 that the solution of the calibration equation converges at λ=(Σ_{j∈S} dⱼxⱼxⱼ^{T})⁻¹(Σ_{j∈S} dⱼxⱼ−tₓ). Therefore, wⱼ=dⱼ[1+xⱼ^{T}(Σ_{j∈S} dⱼxⱼxⱼ^{T})⁻¹(Σ_{j∈S} dⱼxⱼ−tₓ)]. Let \hat{β}ₛ be the solution to the equation

$${\sum }_{j ∈ S}^{ } {d}_{j} {x}_{j} ( {y}_{j} - {x}_{j}^{T} {\hat{β}}_{s} ) = 0.$$

Then the estimator ŝ_{cal} can be written as

$${\hat{s}}_{cal} = \frac{1}{N} {\sum }_{j ∈ S}^{ } {w}_{j} {y}_{j} = {\hat{s}}_{sp 1} + \frac{1}{N} {( {t}_{x} - {\sum }_{j ∈ S}^{ } {d}_{j} {x}_{j} )}^{T} {\hat{β}}_{s} ,$$

which takes the form of a generalized regression estimator (GREG). Applying results on the asymptotic variance of GREG to obtain the asymptotic variance of the estimator ŝ_{cal}:

$$V ( {\hat{s}}_{cal} ) = {\sum }_{j ∈ R}^{ } {\sum }_{j ∈ R}^{ } ( {Δ}_{jl} / {π}_{jl} ) ( {w}_{j} {ɛ}_{j} ) ( {w}_{l} {ɛ}_{l} ) .$$

Since it has been shown that all estimators with distance functions satisfying conditions (i)-(iii) are asymptotically equivalent, all estimators have the same asymptotic variance V(ŝ_{cal}). When the sample S is large enough, the Central Limit Theorem applies. Therefore, for a given constant or α ∈ (0,1), s_{Q} is bounded by (ŝ_{cal}−z_{α/2}\sqrt{V(ŝ_{cal})}, ŝ_{cal}+z_{α/2}\sqrt{V(ŝ_{cal})} with probability 1−α.

Utilizing multi-attribute synopses. In the discussion, it has been assumed that there is prior knowledge of the selectivities sᵢ of individual predicates Pᵢ based on single-attribute synopsis structures. However, it will be understood that the estimation procedure can be advantageously extended so that multi-attribute synopsis structures can also be utilized when they are present.

For example, suppose that a multi-dimensional synopsis exists on a set of attributes A. Thus, in accordance with one method of the invention it is straightforward to derive lower-dimensional synopses from higher-dimensional synopses, i.e., synopses on any subset(s) of A can be obtained from the synopsis on A. Let A_{Q} be the set of attributes involved in query Q. If A∩A_{Q}≠Ø, the synopsis on A can be utilized. Let U=A∩A_{Q}, and let P_{U} be the conjuncts of predicates in which attributes in U are involved. Then the selectivity s_{U} of P_{U} can be estimated based on the synopsis on U. We augment the auxiliary vector xⱼ by an additional element reflecting whether j satisfies P_{U}. Changes are also made accordingly to tₓ, with the addition of an element with value s_{U}. The algorithms for solving the calibration equations presented above can then be applied in order to obtain ŝ_{cal}.

Experimental evaluation. This section reports the results of an experimental evaluation of the estimation methods disclosed herein. The following compares the accuracy of the methods in accordance with the invention with that of the synopsis-based and sampling-based approaches using synthetic as well as a real data set. The real data set used is the Census Income data.

Synthetic data are used to study the properties of the methods presented herein in a controlled manner. A large number of synthetic data sets are generated by varying the following parameters:

Data skew: The data in each attribute are generated from a Zipfian distribution with parameter z ranging from 0 (uniform distribution) to 3 (highly-skewed distribution). The number of distinct values in each attribute is fixed to 10.

Correlation: By default, the data are independently generated for each attribute. We introduce correlation between a pair of attributes by transforming the data such that the correlation coefficient between the two attributes is approximately ρ. The parameter ρ ranges from 0 to 1, representing an increasing degree of correlation. In particular, ρ=0 corresponds to the case where there is no correlation between the two attributes; ρ=1 indicates that the two attributes are fully dependent, i.e., knowing the value of one attribute enables one to perfectly predict the value of the other attribute. This is achieved by first independently generating the data for both attributes (say, A₁ and A₂) and then performing the following transformation. For each tuple with Aᵢ=a₁ and A₂=a₂, replace a₂ by a₁×ρ+a₂×\sqrt{1−p²}, suitably rounded. For three or more attributes, create data such that the correlation coefficient between any pair of attributes is approximately ρ.

The real data set Census Income contains weighted census data extracted from the 1994 and 1995 population surveys conducted by the U.S. Census Bureau. It has 199,523 tuples and 40 attributes representing demographic and employment related information. Out of the 40 attributes, 7 are continuous, and 33 are nominal.

The following evaluates the methods presented herein on two different query workloads. The first set of queries consist of 100 range queries where each predicate in the query takes the form of (attribute<=constant) with randomly chosen constant. The second set of queries consist of 100 equality queries where each predicate takes the form of (attribute=constant) where constant is randomly chosen.

It will also be appreciated that simple random sampling are used as the sampling scheme in the experiments for both the sampling-based approach and the methods presented herein. All numbers reported are averages of 30 repetitions.

It will also be understood that the exact frequency distributions of individual attributes as the synopses are used, and that the absolute relative error defined in Eq. (1) is used as the error metric.

Results on synthetic data. In all experiments, similar trends are observed for both range and equality queries; thus only the results on range queries are reported because of space limitations.

First the effects of various parameters in the case of two attributes (i.e., only two predicates on two different attributes are involved in the query) are shown, and then show the effect of the number of attributes on the estimation accuracy. The individual selectivities are obtained based on the frequencies of values in each attribute. Since results indicate that the number of tuples T in the table does not have a significant effect on the accuracy of the estimators, only the results for T=100,000 are shown here.

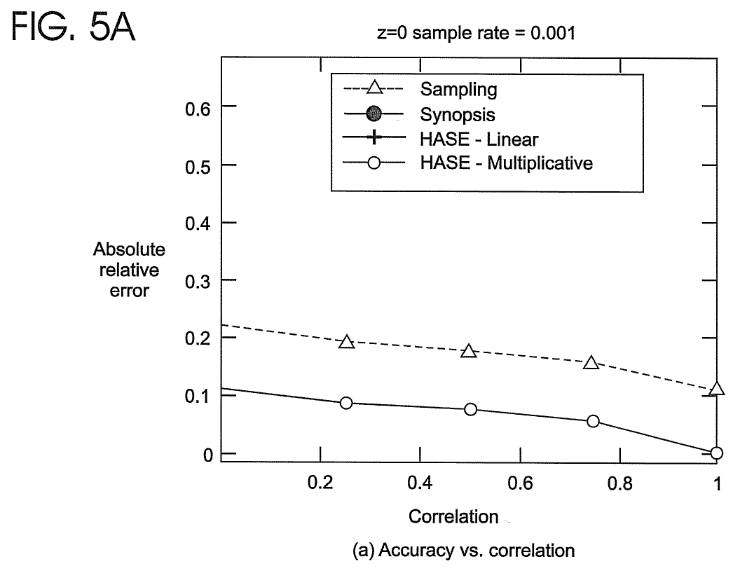

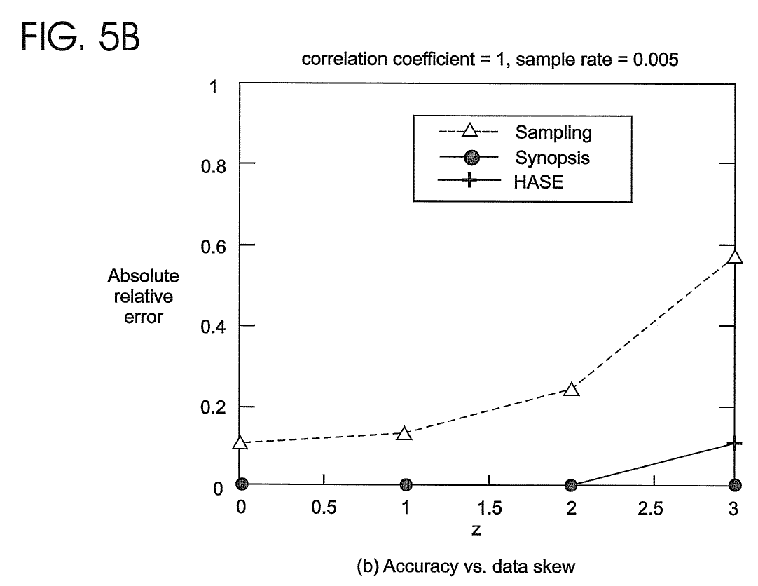

Correlation. The effect of the correlation between attributes on the estimation accuracy by varying the correlation coefficient ρ from 0 to 1, representing an increasing degree of correlation. are shown. FIG. 5A presents a typical result.

The accuracy of the methods in accordance with the present invention increase with the degree of correlation. Since the methods utilize sample information, when the degree of correlation increases, the number of distinct value combinations in the two attributes decreases, as the data become more “concentrated”. Therefore, the sample space (containing all distinct value combinations) becomes smaller, and thus sampling becomes more efficient (i.e., for a given sample rate, it is more likely to include in the sample a tuple satisfying the query).

In addition, as the degree of correlation increases, the benefit of adjusting the weights in accordance with known single-attribute synopses becomes more evident. In the extreme case where the two attributes are fully dependent (ρ=1), it essentially produces the exact selectivity, provided that there is at least one tuple in the sample satisfying the query.

To understand why this is the case, consider the following query: Q=P₁∩P₂=(A₁=a)∩(A₂=b). Full dependency dictates that if there is at least one tuple in the table satisfying this query, then for any other value c (c≠a)in A₁ and d (d≠b) in A₂, both (A₁=a)∩(A₂=d) and (A₁=c)∩(A₂=b) evaluate to false. This implies that s=s₁=s₂.

Therefore, if in the auxiliary vector xⱼ for tuple j, we have xⱼ₁=1 (which corresponds to A₁=a), then yⱼ(the variable indicating whether j satisfies Q) must also be 1, and vice versa. Since we know s₁, we have

$$\frac{1}{N} {\sum }_{j ∈ S}^{ } {w}_{j} {x}_{j 1} = {s}_{1}$$

as a constraint in the optimization problem. If we can find a set of wⱼ that satisfy this constraint, then the calibration estimator

$$\frac{1}{N} {\sum }_{j ∈ S}^{ } {w}_{j} {y}_{j}$$

must also yield s₁, which means a perfect selectivity estimate.

One exception to this analysis is that when there is no tuple j ∈ S satisfying Q, it may no longer be possible to produce the exact estimate. In such cases, all yⱼ(j ∈ S) are 0; therefore, regardless of the weights, the calibration estimator 1/N Σ_{j∈S} wⱼyⱼ will also be zero, which may be different from the exact selectivity.

In all cases, the methods disclosed herein produce significantly more accurate estimates than the sampling-based method, with a 50%-100% reduction in error. Both distance functions give very close estimates, verifying the claim that estimators using different distance functions are asymptotically equivalent.

Data skew. The effect of data skew by varying the Zipfian parameter z from 0 (uniform) to 3 (highly-skewed), a typical result is shown in FIG. 5(b) It will be seen that the errors increase as the data becomes increasingly more skewed. The reason is that when the data skew in each attribute increases, the frequencies of some value combinations decrease. As a result, when there is a query on those value combinations with low occurrence frequencies, it becomes increasingly possible that no sampled tuple can satisfy the query. This gives rise to more errors, because with no sampled tuple satisfying the query, the estimate has to be zero, whereas the actual selectivities are not.

Note that this situation is different from the case of increasing correlation as discussed above. The main effect of increasing the skew is a decrease in the frequencies of some value combinations, not necessarily reducing the number of value combinations present in the table. Increasing correlation, on the other hand, generally results in a reduction in the number of value combinations.

Another interesting observation from FIG. 5(b) is that the accuracy of the prior art synopsis-based approach remains virtually the same regardless of the data skew. The reason is as follows. Assuming independence between attributes, the synopsis-based approach estimates the selectivity by ŝₕᵢₛ=s₁*s₂ In FIG. 5(b), the two attributes are fully dependent, which implies that the actual selectivity s=s₁=s₂. Thus, E(ŝₕᵢₛ)=(s−s₁s₂)/s₁=1−s₁. The average error over a large number of (uniformly) randomly selected equality queries is therefore 1−avg(s₁). In this case, since there are 10 distinct values in each attribute, avg(s₁)=1/10=0.1 the average error of the estimate is thus 1−0.1=0.9. Therefore, the accuracy of this approach does not change with data skew in this case.

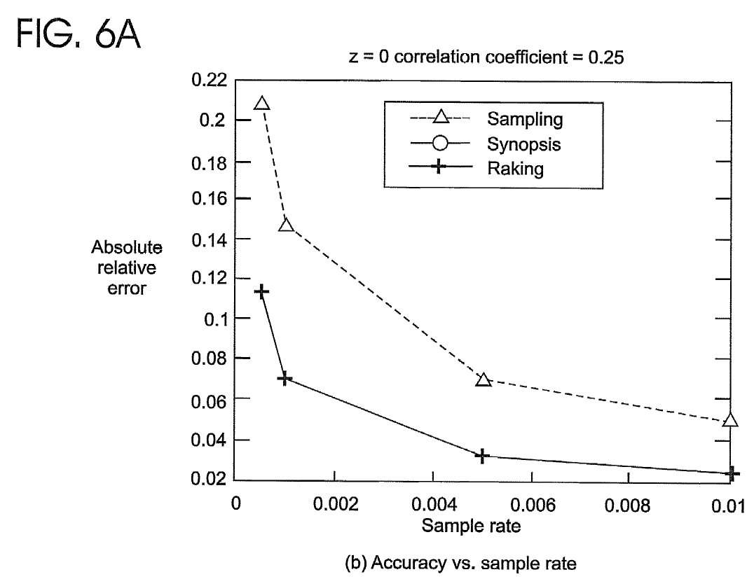

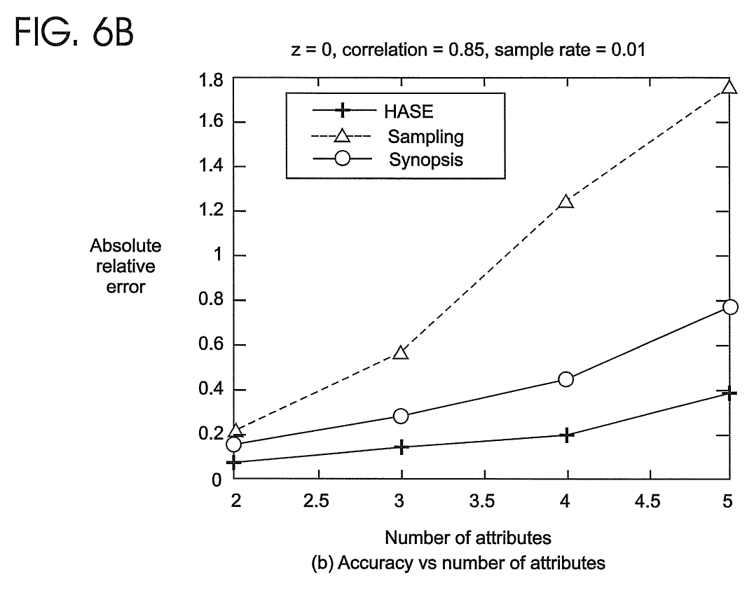

Sample rate FIG. 6A shows a typical result on how the three methods behave as the sample rate is increased. The number of attributes in the data set is 2. The accuracy of the synopsis-based approach remains unchanged across the range of sample rates, because it does not depend on sampling. It will be appreciated that the accuracy of the methods presented herein, in accordance with the present invention, improves with increasing sample rate. For all sample rates, the methods disclosed herein, in accordance with the present invention, improve outperform both the synopsis-based and the sampling-based approaches.

It is also worth noting that with methods of the present invention, the same level of accuracy with a much smaller sample rate than that required by the sampling-based approach may be achieved. For example, in FIG. 6A, the sampling-based approach has an error of 0.07 when the sample rate is 0.005. The methods presented herein achieve approximately the same level of accuracy with a sample rate of 0.001, resulting in a reduction by a factor of 5. It will be appreciated that this translates into more significant I/O savings because of the non-linear relationship between the I/O cost and the sample rate as discussed earlier.

Number of attributes. The number of attributes involved in the query range from 2 to 5 to study the impact of the number of attributes on the estimation accuracy. A typical result is shown in FIG. 6B. Clearly, the accuracy of all three approaches decreases as the number of attributes increases since having more attributes would introduce more sources of errors. A space of higher dimensionality requires a much larger sample to cover a fixed portion of the space, in comparison with a space of lower dimensionality.

Note from FIG. 6B, however, that the methods disclosed herein disclosed herein, in accordance with the present invention, outperforms the other two prior art approaches for all number of attributes, and has a lower rate of decrease in accuracy.

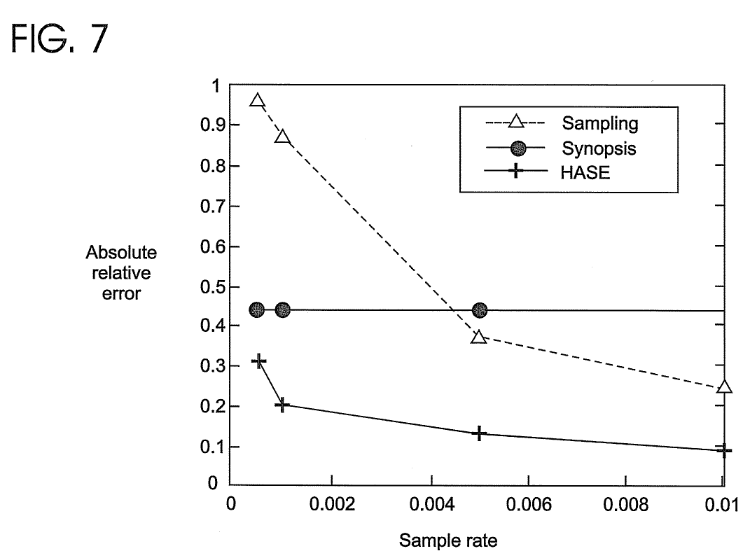

Results on real data. Since the Census Income data has 40 attributes, there are 40×39=1560 attribute pairs. Randomly choosing 100 attribute pairs and recording the accuracy of the methods disclosed herein with prior art approaches, as the sample rate increases, results in FIG. 7. It will be seen that the trends are similar to those for the synthetic data, with the methods of the present invention significantly outperforming both the synopsis-based and the sampling-based approaches. The error response to the number of attributes is also similar to that for the synthetic data, and is therefore omitted here.

It will be understood that the capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for improving selectivity estimation for conjunctive predicates for use in a query optimizer for a relational database management system, the method comprising:
sampling a relational database for generating a sample data set;
estimating cardinalities of the sample data set;
adjusting the estimated cardinalities of the sample data set, wherein adjusting cardinalities of the sample data set comprises:
determining a first weight set;
determining a second weight set; and
minimizing at least one distance between the first weight set and the second weight set.

2. The method as in claim 1, wherein determining the first weight set comprises:
determining a plurality of tuples in the sample data set; and
weighting each of the plurality of tuples in the sample data set according to predetermined statistics.

3. The method as in claim 2 wherein determining the second weight set comprises using a distance function to derive the second weight set.

4. The method as in claim 3 wherein using a distance function further comprises using a linear distance function.

5. The method as in claim 3 wherein using a distance function further comprises using a multiplicative distance function.

6. The method as in claim 1 further comprising determining individual and combined predicates.

7. The method as in claim 6 wherein estimating the cardinalities of the sample data set further comprises estimating the cardinalities with respect to the individual and combined predicates.

8. A relational database management system for improving cardinality estimation for use with a computer system wherein queries are entered for retrieving data, the system comprising:
means for sampling a relational database for generating a sample data set;
means for estimating cardinalities of the sample data set;
means for adjusting the estimated cardinalities of the sample data set, wherein in means for adjusting cardinalities of the sample data set comprises:
means for determining a first weight set;
means for determining a second weight set; and
means for minimizing at least one distance between the first weight set and the second weight set.

9. The relational database management system as in claim 8, wherein determining the first weight set comprises:
means for determining a plurality of tuples in the sample data set; and
means for weighting each of the plurality of tuples in the sample data set according to predetermined statistics.

10. The relational database management system as in claim 8 wherein determining the second weight set comprises means for using a distance function to derive the second weight set.

11. The relational database management system in claim 10 wherein using a distance function further comprises means for using a linear distance function.

12. The relational database management system as in claim 10 wherein using a distance function further comprises means for using a multiplicative distance function.

13. The relational database management system as in claim 8 further comprising means for determining individual and combined predicates.

14. The relational database management system as in claim 13 wherein estimating the cardinalities of the sample data set further comprises means for estimating the cardinalities with respect to the individual and combined predicates.

15. A program storage device readable by a machine, tangibly embodying a program of instructions executable by the machine to perform a method for improving cardinality estimation in a relational database management system, the method comprising:
sampling a relational database for generating a sample data set;
determining individual and combined predicates;
estimating cardinalities of the sample data set, wherein estimating the cardinalities of the sample data set further comprises:
estimating the cardinalities with respect to the individual and combined predicates;
adjusting the estimated cardinalities of the sample data set, wherein adjusting cardinalities of the sample data set comprises:
determining a first weight set, wherein determining the first weight set comprises:
determining a plurality of tuples in the sample data set;
weighting each of the plurality of tuples in the sample data set according to predetermined statistics;
determining a second weight set, wherein determining the second weight set comprises;
using a distance function to derive the second weight set, wherein using the distance function further comprises selecting the distance function from the group consisting of a linear distance function and a multiplicative distance function; and
minimizing at least one distance between the first weight set and the second weight set
